(19) United States
(12) Patent Application Publication
(10) Pub. No.: US 2013/0099672 A1
(43) Pub. Date: Apr. 25, 2013

(54) ILLUMINATION SYSTEM AND CONTROL METHOD OF ILLUMINATION SYSTEM

(71) Applicants: Chih-Hua Lin, Hsin-Chu (TW); Wen-Chi Wu, Hsin-Chu (TW)

(72) Inventors: Chih-Hua Lin, Hsin-Chu (TW); Wen-Chi Wu, Hsin-Chu (TW)

(21) Appl. No.: 13/655,457

(22) Filed: Oct. 19, 2012

(30) Foreign Application Priority Data
Oct. 21, 2011 (CN) 201110322771.9

(51) Int. Cl. H05B 37/02

(52) U.S. Cl. 315/129; 315/294; 315/153

(57) ABSTRACT

The invention discloses an illumination system and a control method of illumination system. The illumination system includes a portable electronic apparatus, a lamp-controlling module and at least one lamp. The control method of an illumination system includes following steps: generating a wireless control signal according to a color distribution of a selected pattern; generating a lamp-controlling signal according to the wireless control signal; respectively adjusting a light-emitting state of the lamp according to the lamp-controlling signal.

### CROSS-REFERENCE TO RELATED APPLICATION

This application claims the priority benefit of China application serial no. 201110322771.9, filed on Oct. 21, 2011. The entirety of the above-mentioned patent application is hereby incorporated by reference herein and made a part of this specification.

### BACKGROUND OF THE INVENTION

1. Field of the Invention

The invention generally relates to an illumination system and control method thereof, and more particularly, to an illumination system and control method of illumination system by using a portable electronic apparatus for controlling.

2. Description of Related Art

Traditional lamp control methods mostly use a controller embedded in a wall, such as a switch controller, for controlling. Generally, the lamp is controlled for being turned on/off only in the prior art. The switch controller usually is connected to a lamp directly or through a line and is often disposed within the visible range of a lamp. When a user operates the switch controller, the user can directly observe the present state (turning on/off) of the lamp.

Although a switch controller, connected to a lamp through a line, may control the lamp state correctly, the switch controller and the lamp are fixed on a fixed position so that the user needs to reluctantly agree the position of the switch controller while using the lamp, which causes inconvenience.

Recently, a controller wireless connecting a lamp could provide convenience in operation and controlling The wireless signal used by the controller and the lamp usually is an infrared (IR) signal or a radio frequency (RF) signal. When an IR signal is used in a controller and a lamp, the controllable range of the controller is reduced and limited by an arrangement of compartments due to IR light unable to penetrate the compartments. In order to avoid the controller from being limited by a power, the controller, wireless linking the lamp, takes a battery as a power. However, changing the battery is annoying. In particular, the controller, wireless linking the lamp, is likely placed anywhere so that the user must take care the location where the controller was placed, which increases the usage inconvenience.

R.O.C. Patent Publication No. M373610 discloses a multi-function GPS mobile phone, in which an electric equipment remote-control module is configured for a user to remotely control electric equipments. Another R.O.C. Patent Publication No. 416201 discloses a mobile phone with a remote-control function and a processing method of the remote-control function. In a remote-control mode, a button mapping figure between the remote-control function items and the corresponding buttons could be shown. When the user presses down a button, a corresponding button mapping figure is shown on the panel of the mobile phone to present the corresponding remote-control function items, so that the user could easily finds out and transmits a corresponding remote-control signal for controlling the external devices. R.O.C. Patent Publication No. 200605625 discloses a wireless remote control used in a mobile phone for remotely controlling a plurality of electronic apparatuses through a wireless network architecture.

US Patent Application Publication No. 2005/0054337 discloses a mobile telephone with remote-controlling capability, a remote-controlling method, and a system thereof for presetting various remote-control codes corresponding to various control operations of a target equipment, wherein the remote-control codes are respectively corresponding to the multiple operation buttons of an operation unit of the mobile phone, and the remote-control codes are stored in the memory of the mobile phone. When an operation button is pressed down, the control unit of the mobile phone reads a remote-control code corresponding to the pressed button from the memory and an IR transmitter unit sends the code to the target equipment. US Patent Application Publication No. 20080057929 discloses a mobile phone and a remote-control system, the system includes the mobile phone, a mobile communication network, a plurality of remote systems, and a server. The remote-control system sends an electronic signal to the mobile phone through the mobile communication network, and then the mobile phone controls the state of the remote-control systems and transmits electronic signals through a processing unit with a control software program. After that, the mobile phone downloads and installs the control software program from a server through the mobile communication network.

### SUMMARY OF THE INVENTION

Accordingly, the invention is directed to an illumination system and a control method thereof, which could adjust the light-emitting luminance and/or the light-emitting hue of a lamp according to a color distribution of a selected pattern.

Other objectives and advantages of the invention should be further indicated by the disclosures of the invention, and omitted herein for simplicity.

To achieve one of, a part of or all of the above-mentioned objectives, or to achieve other objectives, an embodiment of the invention provides an illumination system, which includes a portable electronic apparatus, a lamp-controlling module, and a lamp. The portable electronic apparatus is capable of generating a wireless control signal according to a color distribution of a selected pattern. The lamp-controlling module is coupled to the portable electronic apparatus to generate a lamp-controlling signal according to the wireless control signal. The lamp is coupled to the lamp-controlling module and adjusts a light-emitting state of the lamp according to the lamp-controlling signal.

To achieve one of, a part of or all of the above-mentioned objectives, or to achieve other objectives, an embodiment of the invention provides a control method of an illumination system, in which the illumination system includes at least one lamp and the control method of the illumination system includes following steps: generating a wireless control signal according to a color distribution of a selected pattern; generating a lamp-controlling signal according to the wireless control signal; and adjusting a light-emitting state of the lamp according to the lamp-controlling signal.

Based on the description above, the illumination system and the control method of illumination system in the above-mentioned embodiments of the invention could adjust the light-emitting luminance of the lamp, the light-emitting hue of the lamp or a combination thereof according to the color distribution of the selected pattern and thereby adjust the light-emitting state of the lamp.

Other objectives, features and advantages of the invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and together with the description, serve to explain the principles of the invention.

FIG. 1A is a schematic diagram of an illumination system according to an embodiment of the invention.

FIG. 1B is a schematic diagram of a selected pattern according to an embodiment of the invention.

FIG. 1C is a schematic diagram of a gray level distribution of a selected pattern according to an embodiment of the invention.

FIG. 1D is a schematic diagram of a hue distribution of a selected pattern according to an embodiment of the invention.

FIG. 2 is a schematic system diagram of the lamp-controlling module in FIG. 1A according to an embodiment of the invention.

FIG. 3 is a schematic system diagram of the lamp-controlling module in FIG. 1A according to another embodiment of the invention.

FIG. 4 s a schematic system diagram of the lamp in FIG. 1A according to an embodiment of the invention.

FIG. 5 is a schematic flowchart of a control method of an illumination system according to an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

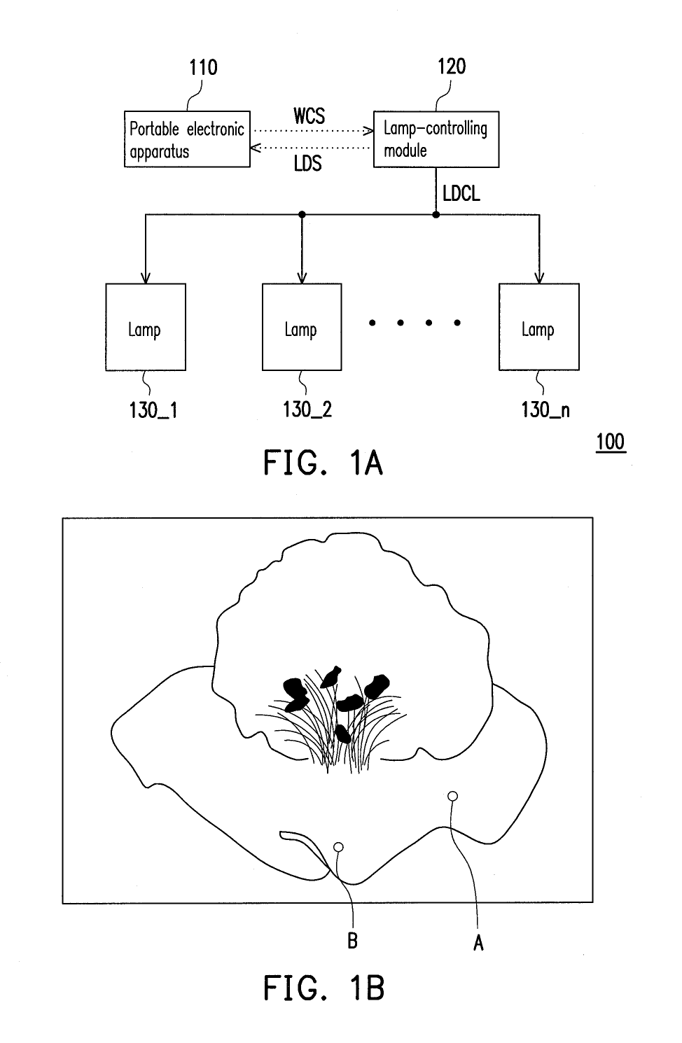

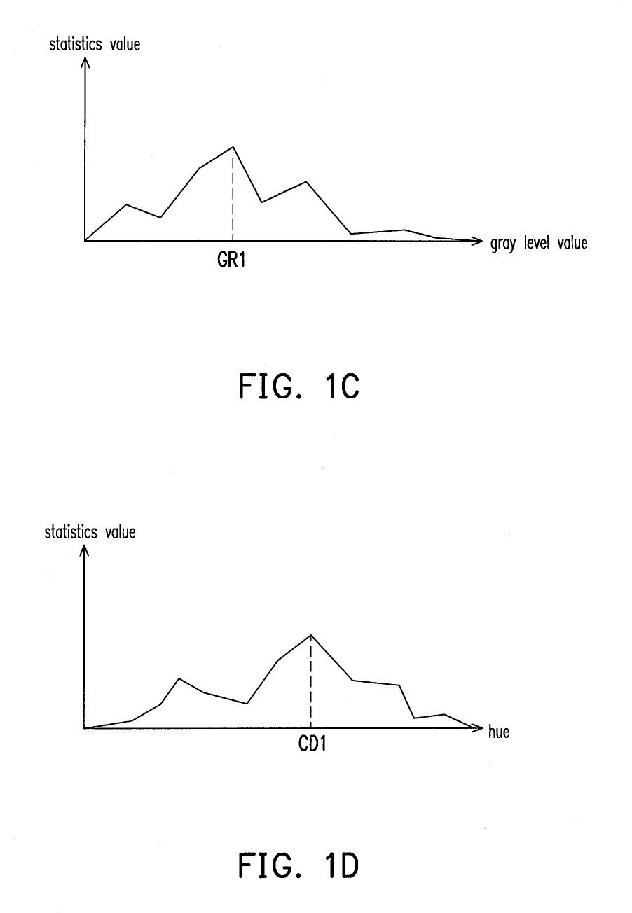

FIG. 1A is a schematic diagram of an illumination system according to an embodiment of the invention. Referring to FIG. 1A, in the embodiment, an illumination system 100 includes a portable electronic apparatus 110, a lamp-controlling module 120, and a plurality of lamps 130_1-130_{—}n, wherein n is a positive integer. The portable electronic apparatus 110 could be a mobile phone and the portable electronic apparatus 110 could execute a control program to display a plurality of preset patterns for a user to choose one of the preset patterns serving as a selected pattern. The portable electronic apparatus 110 generates a wireless control signal WCS according to the color distribution of the selected pattern, and the wireless control signal WCS is sent to the lamp-controlling module 120. The wireless control signal WCS herein is a wireless signal conforming to bluetooth communication protocol or 802.11 communication protocol.

The lamp-controlling module 120 is coupled to the portable electronic apparatus 110 for receiving the wireless control signal WCS and generating a lamp-controlling signal LDCL according to the wireless control signal WCS. Herein the lamp-controlling signal LDCL could be a pulse width modulation (PWM) signal or a DMX signal. The lamps 130_1-130_{—}n are coupled to the lamp-controlling module 120 and respectively adjust the light-emitting states of the lamps 130_1-130_{—}n according to the corresponding lamp-controlling signal LDCL.

FIG. 1B is a schematic diagram of a selected pattern according to an embodiment of the invention. Referring to FIGS. 1A and 1B, in an embodiment of the invention, the adjustable light-emitting state of the lamps 130_1-130_{—}n is a light-emitting luminance. At the time, a control program executed by the portable electronic apparatus 110 could generate the wireless control signal WCS according to the average gray level value of the selected pattern. For example, the pattern has 256 gray levels (i.e., 0-255), if the average gray level value of the selected pattern is approximately 204, the luminance value for the wireless control signal WCS to adjust the lamps 130_1-130_{—}n to be 80%, which 100% representing a maximum luminance. After that, the lamp-controlling module 120 generates the lamp-controlling signal LDCL according to the wireless control signal WCS so as to adjust the luminance value of the lamps 130_1-130_{—}n to be 80%.

Generally speaking, if the wireless control signal WCS are capable of simultaneously setting the lamps 130_1-130_{—}n, the wireless control signal WCS could contain items to be adjusted (control items) and values to be adjusted (control values). In the embodiment, the control item may be, luminance and the control value is, for example, 80%. On the other hand, if the wireless control signal WCS is for setting one of the lamps 130_1-130_{—}n, the wireless control signal WCS could further contain lamp serial number. Here the lamp serial number could be, for example, a code corresponding to one of the lamps 130_1-130_{—}n. Moreover, if the lamps 130_1-130_{—}n are set according to the color distribution of the selected pattern, the portable electronic apparatus 110 could emit a universal wireless control signal WCS to the lamp-controlling module 120 or emit a wireless control signal WCS corresponding to each of the lamps 130_1-130_{—}n to the lamp-controlling module 120, which the invention is not limited to and is determined according to the control way of the lamps 130_1-130_{—}n.

FIG. 1C is a schematic diagram of a gray level distribution of the selected pattern according to an embodiment of the invention. Referring to FIGS. 1A and 1C, in an embodiment of the invention, the control program executed by the portable electronic apparatus 110 could generate the wireless control signal WCS according to a reference gray level value with the highest statistics value in the gray level distribution of the selected pattern (for example, the gray level value GR1). For example, the gray level value GR1 is approximately 153, the luminance value for the wireless control signal WCS to adjust the lamps 130_1-130_{—}n is 60%. After that, the lamp-controlling module 120 generates the lamp-controlling signal LDCL according to the wireless control signal WCS so as to adjust the luminance value of the lamps 130_1-130_{—}n to be 60%.

Referring to FIG. 1B again, the control program executed by the portable electronic apparatus 110 could generate the wireless control signal WCS according to the gray level value of a selected point (for example, A or B) of the selected pattern chosen by the user. For example, if the selected point is A, the wireless control signal WCS would be generated based on the gray level value of the selected point A; if the selected point is B, the wireless control signal WCS would be generated based on the gray level value of the selected point B.

In some embodiments, the adjustable light-emitting states of the lamps 130_1-130_{—}n are light-emitting luminance and light-emitting hue. At the time, the control program executed by the portable electronic apparatus 110 could generate the wireless control signal WCS according to the average gray level value and the average hue value of the selected pattern. Herein the portable electronic apparatus 110 could generate the wireless control signal WCS according to the average gray level value of the selected pattern so as to adjust the light luminance of the lamps 130_1-130_{—}n, and the portable electronic apparatus 110 could generate the wireless control signal WCS according to the average hue value of the selected pattern so as to adjust the light color of the lamps 130_1-130_{—}n.

When the portable electronic apparatus 110 adjusts the light luminance and the light hue of the lamps 130_1-130_{—}n according to the selected pattern, the control item of the wireless control signal WCS includes luminance adjustment and hue adjustment, the control value corresponding to the luminance adjustment could be one of 1%-100% and the control value corresponding to the hue adjustment could be set by one of 0-360. Herein the adjustment interval of the control value can be determined by the design of the lamps 130_1-130_{—}n, which the invention is not limited to.

FIG. 1D is a schematic diagram of a hue distribution of the selected pattern according to an embodiment of the invention. Referring to FIGS. 1A, 1C and 1D, in an embodiment of the invention, the control program executed by the portable electronic apparatus 110 could generate the wireless control signal WCS according to a reference gray level value with the highest statistics value in the gray level distribution of the selected pattern (for example, the gray level value GR1) and the reference hue with the highest statistics value in the hue distribution of the selected pattern (for example, the hue CD1).

Further referring to FIG. 1B, the control program executed by the portable electronic apparatus 110 could generate the wireless control signal WCS according to the gray level value and the hue of a selected point (for example, A or B) of the selected pattern chosen by the user. For example, if the selected point is A, the wireless control signal WCS would be generated based on the gray level value and the hue of the selected point A; if the selected point is B, the wireless control signal WCS would be generated based on the gray level value and the hue of the selected point B.

If the light sources of the lamps 130_1-130_{—}n consist of a plurality of light-emitting groups, the control program executed by the portable electronic apparatus 110 could generate the wireless control signal WCS according to the color distributions of a plurality of areas of the selected pattern so as to respectively set the light-emitting luminance and the light-emitting hue of each of the light-emitting groups. Herein the partition way of the selected pattern (such as lengthwise-cut, crosswise-cut or 9×9 grid) can be designed solely by the people of the professional field, and the number of the control values of the wireless control signal WCS could adjusted according to the number of the light-emitting groups.

In some embodiments, the portable electronic apparatus 110 could have a camera so that the control program executed by the portable electronic apparatus 110 could obtain the light-emitting state (light-emitting luminance and light-emitting hue, for example) of the lamps 130_1-130_{—}n through the camera. The luminance error value (i.e., the error of the real light-emitting luminance from the luminance of adjustment) of each of the lamps 130_1-130_{—}n is computed according to the light-emitting luminance of each of the lamps 130_1-130_{—}n and the luminance setting value (i.e., the luminance obtained by computation on the average gray level value, the reference gray level value or the selected gray level value) of each of the lamps 130_1-130_{—}n. The control program executed by the portable electronic apparatus 110 could generate the wireless control signal WCS according to the luminance error values of the lamps 130_1-130_{—}n.

The control program executed by the portable electronic apparatus 110 could compute a hue error value of each of the lamps 130_1-130_{—}n (i.e., the difference between the real light-emitting hue and the adjusted hue) according to the light-emitting hue of each of the lamps 130_1-130_{—}n and the hue setting value (i.e., the average hue value, the reference hue or the selected hue) of each of the lamps 130_1-130_{—}n. The control program executed by the portable electronic apparatus 110 could generate the wireless control signal WCS according to the luminance error value and the hue error value of the lamps 130_1-130_{—}n.

Referring to FIG. 1A, in an embodiment of the invention, after the lamp-controlling module 120 receives the wireless control signal WCS, a lamp state signal LDS is fed back to the portable electronic apparatus 110. When the portable electronic apparatus 110 transmits the wireless control signal WCS and the lamp state signal LDS has not been received yet in a preset duration (for example, 3 sec.), the portable electronic apparatus 110 would determine that the lamp-controlling module 120 has not received the wireless control signal WCS so as to transmit the wireless control signal WCS again; when the portable electronic apparatus 110 transmits the same wireless control signal WCS a preset number of times (for example, 5 times), an error message is displayed to remind the user of a network connection error; when the portable electronic apparatus 110 receives the lamp state signal LDS, the light-emitting state of the lamps 130_1-130_{—}n is displayed according to the lamp state signal LDS.

In addition, the user could turn on/off all or one of the lamps 130_1-130_{—}n via the portable electronic apparatus 110, and at the time, the control item of the wireless control signal WCS could be turning on the lamp or turning off the lamp. Since turning on/off the lamp is a simple switching operation, the control value corresponding to turning on the lamp or turning off the lamp could be zero, but in other embodiments, the control value could be any one fixed value decided by the people skilled in the art. The user could choose the lamp to adjust the light-emitting state thereof through an interface provided by the control program executed by the portable electronic apparatus 110, i.e., the user could choose one or, a part of or all of the lamps 130_1-130_{—}n for adjusting.

In some embodiments, in order to make the wireless control signal WCS checked, the wireless control signal WCS could include a checking code which is the sum of other fields in the wireless control signal WCS, for example, the sum of the control item and the control value, or the sum of the lamp serial number, the control item, and the control value. The checking code may be the parity check code of other fields (for example, odd parity check code or even parity check code) in the wireless control signal WCS, for example, the odd parity check code of the control item and the control value or the odd parity check code of the lamp serial number, the control item, and the control value. When the wireless control signal WCS is found as being wrong, the wrong wireless control signal WCS is discarded.

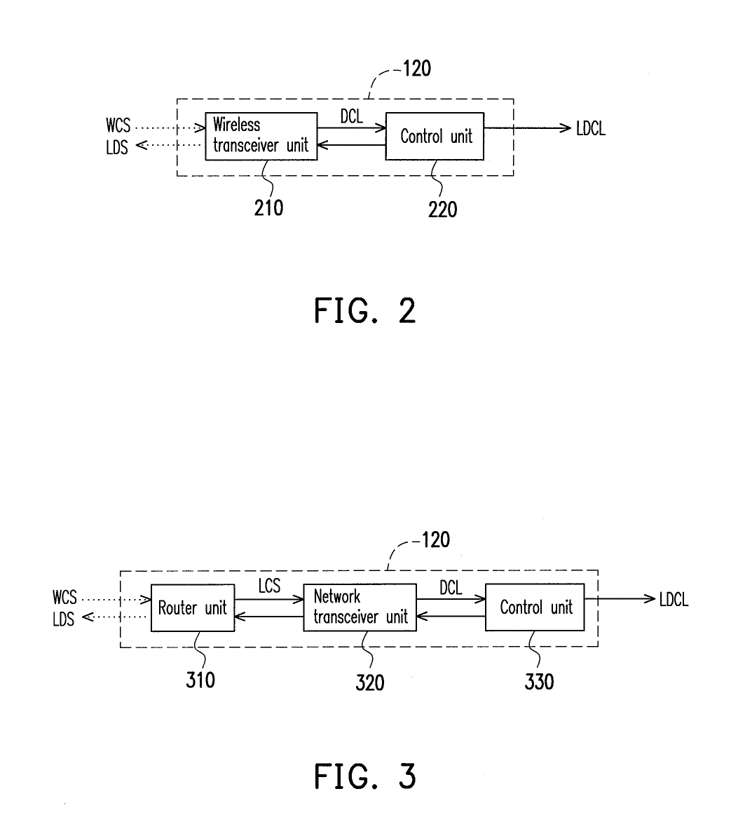

FIG. 2 is a schematic system diagram of the lamp-controlling module in FIG. 1A according to an embodiment of the invention. Referring to FIG. 2, in the embodiment, the lamp-controlling module 120 includes a wireless transceiver unit 210 and a control unit 220. The wireless transceiver unit 210 receives the wireless control signal WCS so as to output a control data DCL to the control unit 220. The control unit 220 outputs the lamp-controlling signal LDCL according to the control data DCL. When the control unit 220 outputs the lamp-controlling signal LDCL according to the control data DCL, the control unit 220 would send out the lamp state signal LDS through the wireless transceiver unit 210.

FIG. 3 is a schematic system diagram of the lamp-controlling module in FIG. 1A according to another embodiment of the invention. Referring to FIG. 3, in the embodiment, the lamp-controlling module 120 includes a router unit 310, a network transceiver unit 320 and a control unit 330. The router unit 310 receives the wireless control signal WCS so as to output a wired control signal LCS. The network transceiver unit 320 receives the wired control signal LCS and thereby outputs a control data DCL to the control unit 330. The control unit 330 outputs the lamp-controlling signal LDCL according to the control data DCL. When the control unit 330 outputs the lamp-controlling signal LDCL according to the control data DCL, the control unit 330 would send out the lamp state signal LDS through the network transceiver unit 320 and the router unit 310, in which the wired control signal LCS could be an Ethernet signal.

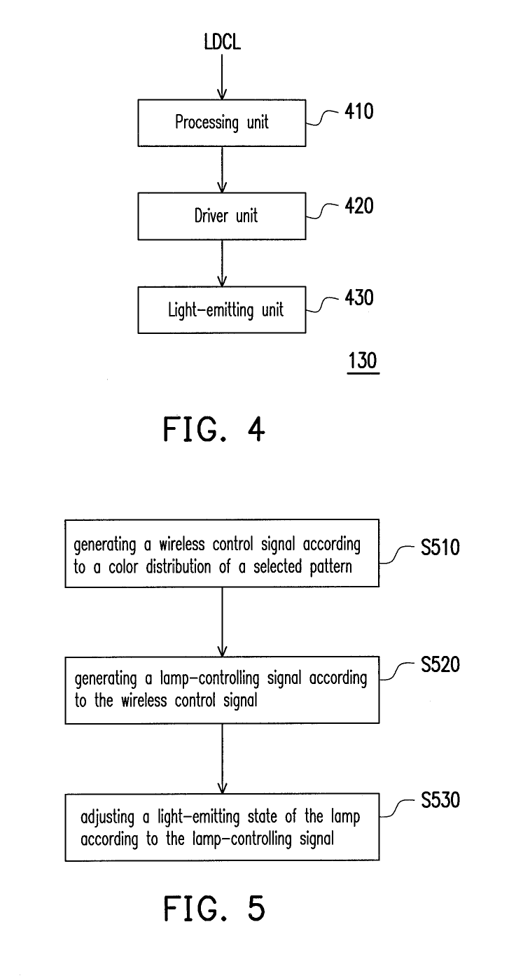

FIG. 4 s a schematic system diagram of the lamp in FIG. 1A according to an embodiment of the invention. Referring to FIG. 4, in the embodiment, the lamp 130 includes a processing unit 410, a driver unit 420 and a light-emitting unit 430. The processing unit 410 receives the lamp-controlling signal LDCL and thereby adjusts one of or all of the light-emitting luminance and the light-emitting hue of the light-emitting unit 430 through the driver unit 420. The light-emitting unit 430 herein consists of all of or one of a bulb and light-emitting diode (LED). The light-emitting unit 430 could be multiple bulbs, multiple LEDs or a combination thereof, which are laid out like a light panel and designed by the people skilled in the art and the invention is not limited to.

FIG. 5 is a schematic flowchart of a control method of an illumination system according to an embodiment of the invention. Referring to FIG. 5, in the embodiment, the wireless control signal is generated according to a color distribution of a selected pattern (step S510). Then, a lamp-controlling signal is generated according to the wireless control signal (step S520). Finally, a light-emitting state of the lamp is adjusted according to the lamp-controlling signal (step S530). The details of the above-mentioned steps can refer to the above-mentioned explanations of the embodiments, which is omitted to describe.

In addition, if the adjustable light-emitting state of the lamp is light-emitting luminance, the wireless control signal is generated according to an average gray level value of the selected pattern, a reference gray level value with the highest statistics value in the gray level distribution of the selected pattern or the gray level value of the selected point. If the adjustable light-emitting state of the lamp is light-emitting luminance and light-emitting hue, the wireless control signal is generated according to an average hue value of the selected pattern, a reference hue with the highest statistics value in the hue distribution of the selected pattern or the hue of the selected point.

In summary, the embodiments of the invention have at least one of the following advantages. The illumination system and the control method thereof could adjust the light-emitting luminance, the light-emitting hue or a combination thereof of a lamp according to the color's distribution of a selected pattern and thereby intuitively adjust the light-emitting state of the lamp. The light-emitting state of each lamp could be obtained through a camera, so that the luminance error and the hue error corresponding to each lamp can be calculated so as to make the lamp adjustment more accurate. In addition, after the portable electronic apparatus sends out the wireless control signal but the lamp state signal is not received, the wireless control signal is sent out again. When the portable electronic apparatus transmits the wireless control signal a preset number of times, an error message is prompted to remind the user of a network connection error.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a portable electronic apparatus, capable of generating a wireless control signal according to a color distribution of a selected pattern;
a lamp-controlling module, coupled to the portable electronic apparatus to generate a lamp-controlling signal according to the wireless control signal; and
a lamp, coupled to the lamp-controlling module, wherein the lamp adjusts a light-emitting state of the lamp according to the lamp-controlling signal.

2. The illumination system as claimed in claim 1, wherein the portable electronic apparatus executes a control program to display a plurality of preset patterns and the selected pattern is one of the preset patterns.

3. The illumination system as claimed in claim 1, wherein the light-emitting state of the lamp comprises a light-emitting luminance.

4. The illumination system as claimed in claim 3, wherein the control program generates the wireless control signal according to an average gray level value of the selected pattern.

5. The illumination system as claimed in claim 3, wherein the control program generates the wireless control signal according to a reference gray level value with the highest statistics value in a gray level distribution of the selected pattern.

6. The illumination system as claimed in claim 3, wherein a selected point is chosen from the selected pattern and the control program generates the wireless control signal according to a gray level value of the selected point.

7. The illumination system as claimed in claim 3, wherein the light-emitting state of the lamp further comprises a light-emitting hue.

8. The illumination system as claimed in claim 7, wherein the control program generates the wireless control signal according to an average gray level value and an average hue value of the selected pattern.

9. The illumination system as claimed in claim 7, wherein the control program generates the wireless control signal according to a reference gray level value with the highest statistics value in a gray level distribution of the selected pattern and a reference hue with the highest statistics value in a hue distribution of the selected pattern.

10. The illumination system as claimed in claim 7, wherein a selected point is chosen from the selected pattern and the control program generates the wireless control signal according to a gray level value and a hue of the selected point.

11. The illumination system as claimed in claim 1, wherein the lamp comprises a plurality of light-emitting groups, and the control program generates the wireless control signal according to a color distribution of a plurality of pattern areas of the selected patterns, so as to respectively set a light-emitting luminance and a light-emitting hue of each of the light-emitting groups.

12. The illumination system as claimed in claim 1, wherein the portable electronic apparatus comprises a camera, and the control program obtains the light-emitting state of the lamp through the camera, computes a luminance error value of the lamp according to the light-emitting state of the lamp, and generates the wireless control signal according to the luminance error value.

13. The illumination system as claimed in claim 12, wherein the control program further computes a hue error value of the lamp according to the light-emitting state of the lamp and generates the wireless control signal according to the luminance error value and the hue error value of the lamp.

14. The illumination system as claimed in claim 1, wherein after the lamp-controlling module receives the wireless control signal, a lamp state signal is fed back; when the portable electronic apparatus transmits the wireless control signal and the lamp state signal has not been received yet in a preset duration, the portable electronic apparatus transmits the wireless control signal again; when the portable electronic apparatus transmits the wireless control signal a preset number of times, an error message is displayed; when the portable electronic apparatus receives the lamp state signal, the light-emitting state of the lamp is displayed according to the lamp state signal.

15. A control method of an illumination system, wherein the illumination system comprises at least one lamp and the method comprises:
generating a wireless control signal according to a color distribution of a selected pattern;
generating a lamp-controlling signal according to the wireless control signal; and
respectively adjusting a light-emitting state of the lamp according to the lamp-controlling signal.

16. The control method of an illumination system as claimed in claim 15, wherein the selected pattern is one of a plurality of preset patterns.

17. The control method of an illumination system as claimed in claim 15, wherein the light-emitting state of the lamp comprises a light-emitting luminance.

18. The control method of an illumination system as claimed in claim 15, wherein the step of generating the wireless control signal according to a color distribution of the selected pattern comprises:
generating the wireless control signal according to an average gray level value of the selected pattern.

19. The control method of an illumination system as claimed in claim 15, wherein the step of generating the wireless control signal according to a color distribution of the selected pattern comprises:
generating the wireless control signal according to a reference gray level value with the highest statistics value in a gray level distribution of the selected pattern.

20. The control method of an illumination system as claimed in claim 17, wherein the light-emitting state of the lamp further comprises a light-emitting hue.

21. The control method of an illumination system as claimed in claim 20, wherein the step of generating the wireless control signal according to a color distribution of the selected pattern comprises:
generating the wireless control signal according to an average gray level value and an average hue value of the selected pattern.

22. The control method of an illumination system as claimed in claim 20, wherein the step of generating the wireless control signal according to a color distribution of the selected pattern comprises:
generating the wireless control signal according to a reference gray level value with the highest statistics value in a gray level distribution of the selected pattern and a reference hue with the highest statistics value in a hue distribution of the selected pattern.

23. The control method of an illumination system as claimed in claim 20, wherein the step of generating the wireless control signal according to a color distribution of the selected pattern comprises:
generating the wireless control signal according to a gray level value and a hue of the selected point of the selected pattern.

24. The control method of an illumination system as claimed in claim 15, wherein the lamp respectively comprises a plurality of light-emitting groups, and the step of generating the wireless control signal according to a color distribution of the selected pattern comprises:
generating the wireless control signal according to a plurality of color distributions of a plurality of pattern areas of the selected pattern;
wherein a light-emitting luminance and a light-emitting hue of each of the light-emitting groups are set respectively according to the corresponding pattern area.

25. The control method of an illumination system as claimed in claim 15, further comprising:
computing a luminance error value of the lamp according to the light-emitting state of the lamp, wherein the light-emitting state of the lamp is obtained through a camera; and
generating the wireless control signal according to the luminance error value of the lamp.

26. The control method of an illumination system as claimed in claim 15, further comprising:
computing a luminance error value and a hue error value of the lamp according to the light-emitting state of the lamp, wherein the light-emitting state of the lamp is obtained through a camera; and
generating the wireless control signal according to the luminance error value and the hue error value of the lamp.
